(19) United States
(12) Patent Application Publication
(10) Pub. No.: US 2009/0141175 A1
(43) Pub. Date: Jun. 4, 2009

(54) Handheld apparatus and operating method thereof

(75) Inventor: Teng-Fu Hsu, Taipei (TW)

Correspondence Address: REED SMITH LLP, Suite 1400, 3110 Fairview Park Drive, Falls Church, VA, 22042, US

(73) Assignee: Compal Communications, Inc.

(21) Appl. No.: 12/292,940

(22) Filed: Dec. 1, 2008

(30) Foreign Application Priority Data
Nov. 30, 2007 (TW) 096145515

(51) Int. Cl. H04N 9/73

(52) U.S. Cl. 348/657; 348/E09.049

(57) ABSTRACT

The invention provides a handheld apparatus and an operating method thereof. The handheld apparatus is electrically connected to a RGB color temperature sensor. The handheld apparatus comprises a receiving module, a signal converting module, and a color temperature calculating module. The receiving module is for receiving a set of RGB analog color temperature of an environment which the handheld apparatus lies in from the RGB color temperature sensor. The signal converting module is electrically connected to the receiving module, for converting the set of RGB analog color temperature into a digital color temperature signal. The color temperature calculating module is electrically connected to the signal converting module, for generating an absolute color temperature related to the environment, based on the digital color temperature signal.

### BACKGROUND OF THE INVENTION

1. Field of the invention

The present invention relates generally to a handheld apparatus, and more particularly, the present invention relates to a handheld apparatus which can automatically white balance an image based on an absolute color temperature related to an environment which the handheld apparatus lies in, and an operating method thereof.

2. Description of the Prior Art

If there is a color difference in a digital photo, it is generally owing to the inaccuracy of white balance. The so-called “white balance”, as implied by the name, is to make an image apparatus reinstate to its accurate judgment on “white color”. A complete spectrum of the sunlight (white light) comprises red, orange, yellow, green, blue, indigo and violet, for a total of seven colors. An object itself reveals its own color by reflecting white light. However, if the composition of white light is slightly different, the color of an object would be directly or indirectly changed and the color difference is then formed. For a traditional camera using negatives for capturing, when there is a color difference on the photo, the color is adjusted by a color temperature mirror. As for the color difference on the photo captured by a digital camera, the photo needs to be white balanced.

According to practical capturing experiences, a color difference on a photo happens especially when the light of the capturing environment is man-made. The difference of the color temperature of lighting equipment results in a different extent of color difference on a photo. For example, photos captured under the environment with tungsten lamp light are usually more yellow; photos captured outdoors under the bright sky are usually bluer.

The concept of color temperature is to quantify an abstract color using a specific value. The unit of color temperature is usually expressed by an absolute temperature (Kelvin), the value is a measured absolute temperature when a black body completely absorbing any visible light is heated to light. When the color temperature is low (2000K˜3000K), the black body emits red light; when the color temperature is high (6500K˜9000K), the black body emits blue light.

General mobile phones with a digital camera function on the market mostly adopt CMOS sensors for auto white balancing the captured image. However, the final result after the digital imaging process by auto white balance (AWB) is often not as ideal as expected. The main reason is that the CMOS sensor collects a specific size of image and gets a “relative color temperature” after calculation. The auto white balancing function of general mobile phones is to adjust the color tones of the captured image as a whole to the white color temperature (5600K) based on the relative color temperature.

Because the CMOS sensor is adopted in the prior art to detect a relative color temperature in an image area related to the whole environment, but not the absolute color temperature of the environment which the mobile phone lies in while capturing images. Therefore, a bad auto white balance easily results.

Accordingly, the main aspect of the present invention is to provide a handheld apparatus which can automatically white balance an image based on an absolute color temperature related to an environment which the handheld apparatus lies in, and an operating method thereof to solve the problems mentioned above.

### SUMMARY OF THE INVENTION

The present invention provides a handheld apparatus which can automatically white balance an image based on an absolute color temperature related to an environment which the handheld apparatus lies in, and an operating method thereof to make the result after the imaging process reach the closest real situation.

An embodiment of the present invention is a handheld apparatus. The handheld apparatus is electrically connected to a RGB color temperature sensor. The handheld apparatus comprises a receiving module, a signal converting module, and a color temperature calculating module. The receiving module is for receiving a set of RGB analog color temperatures of an environment which the handheld apparatus lies in from the RGB color temperature sensor. The signal converting module is electrically connected to the receiving module, for converting the set of RGB analog color temperatures into a digital color temperature signal. The color temperature calculating module is electrically connected to the signal converting module, for generating an absolute color temperature related to the environment based on the digital color temperature signal.

Compared to the prior art, the handheld apparatus and the operating method thereof of the present invention can automatically white balance an image based on an absolute color temperature related to an environment which the handheld apparatus lies in. Thereby, the handheld apparatus and the operating method thereof of the present invention can avoid the bad result owing to the image is white balanced based on the relative color temperature.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 is a functional block illustrating a handheld apparatus according to the first embodiment of the present invention.

FIG. 2 is a functional block illustrating the handheld apparatus in FIG. 1 further comprising an auto white balancing module, a database, a controlling module, a back-light module, an operation interface and a capturing module.

FIG. 3 is a flow chart demonstrating a method of operating the handheld apparatus according to the second embodiment of the invention.

FIG. 4 is a flow chart demonstrating the method of operating the handheld apparatus in FIG. 3 further comprising steps S4˜S7.

### DETAILED DESCRIPTION OF THE INVENTION

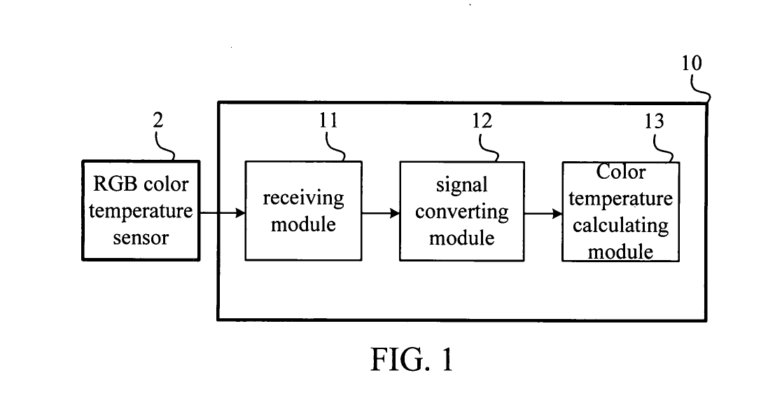

The first embodiment of the present invention is a handheld apparatus. Please refer to FIG. 1. FIG. 1 is a functional block illustrating the handheld apparatus. As illustrated in FIG. 1, the handheld apparatus 10 is electrically connected to a RGB color temperature sensor 2. Namely, the RGB color temperature sensor 2 could be disposed outside the handheld apparatus 10, such as embedded wherever on the surface of the handheld apparatus 10.

The handheld apparatus 10 comprises a receiving module 11, a signal converting module 12, and a color temperature calculating module 13. The receiving module 11 is for receiving a set of RGB analog color temperatures of an environment which the handheld apparatus 10 lies in from the RGB color temperature sensor 2. The signal converting module 12 is electrically connected to the receiving module 11, for converting the set of RGB analog color temperatures into a digital color temperature signal. The color temperature calculating module 13 is electrically connected to the signal converting module 12, for generating an absolute color temperature related to the environment based on the digital color temperature signal.

In practical applications, the set of RGB analog color temperatures is detected by the RGB color temperature sensor 2. As implied by the name, the value of R (red), G (green), B (blue) in the set of RGB analog color temperatures are analog values. The signal converting module 12 could be an ADC converter. By means of the ADC converter, the set of analog color temperature values detected by the RGB color temperature sensor 2 could be converted into a digital color temperature signal.

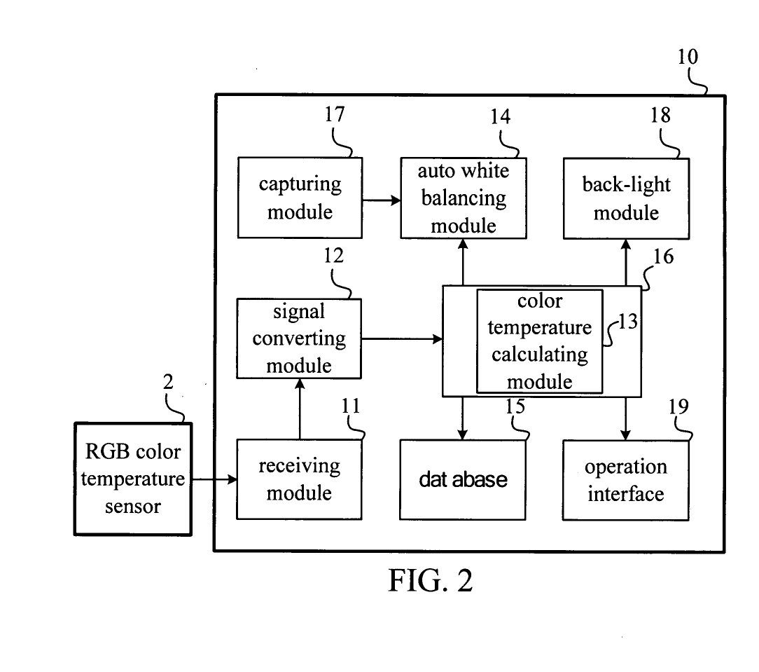

Additionally, the handheld apparatus 10, as illustrated in FIG. 2, further comprises an auto white balancing module 14, a database 15, a controlling module 16 and a capturing module 17. The controlling module 16 comprises the color temperature calculating module 13. The auto white balancing module 14 and the database 15 are electrically connected to the controlling module 16. The capturing module 17 is electrically connected to the auto white balancing module 14 for capturing an image. The database 15 stores a plurality of default results such as color-temperature conversion table. The color temperature calculating module 13 could generate an absolute color temperature related to the environment based on the digital color temperature signal. The auto white balancing module 14 could white balance the image captured by capturing module 17 according to the absolute color temperature. The controlling module 16 could control a display mode of the handheld apparatus 10 according to the absolute color temperature.

Yet as illustrated in FIG. 2, the handheld apparatus 10 further comprises a back-light module 18 and an operation interface 19. The back-light module 18 and the operation interface 19 are electrically connected to the controlling module 16. According to the absolute color temperature, the controlling module 16 could not only control a back-light color and a back-light brightness of the back-light module 18, but also control an operation interface color and an operation interface brightness of the operation interface 19.

For example, when users using a camera phone according to the present invention to capture a digital photo, the receiving module of the camera phone receives a set of RGB analog color temperatures of an environment which the camera phone lies in from the RGB color temperature sensor. Subsequently, the set of RGB analog color temperatures are converted into a digital color temperature signal by means of the ADC converter. Then, the camera phone could select an absolute color temperature from the color-temperature conversion table according to the digital color temperature signal. After determining the absolute color temperature, the digital photo captured by the camera phone could be automatically white balanced based on the absolute color temperature so as to make the color of the digital photo reach the closest real situation. The example is not limited to a camera phone as mentioned above; the present invention could be applied to all PDAs, digital cameras or other handheld apparatuses with capturing modules.

Moreover, the camera phone could control its display mode, the back-light color/brightness or the operation interface color/brightness based on the absolute color temperature. Namely, the camera phone could control its display mode, the back-light color/brightness or the operation interface color/brightness based on the absolute color temperature of the environment or the color of users' dress.

For example, if users want to switch the operation mode of their mobile phone according to the color of their dress, what they need to do is only to capture a photo from their dress. The RGB color temperature sensor of the mobile phone could receive a set of RGB analog color temperatures of the environment which the mobile phone lies in, and the set of RGB analog color temperatures is converted into a digital color temperature signal by means of the ADC converter. Subsequently, the mobile phone could select an absolute color temperature related to the color of users' dress from the color-temperature conversion table based on the digital color temperature signal. After determining the absolute color temperature, the mobile phone could adjust or switch its display mode according to the absolute color temperature.

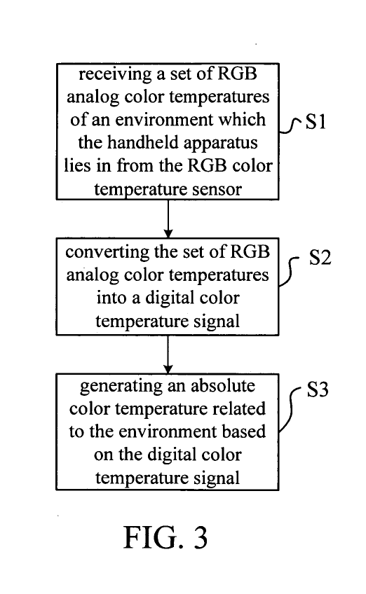

The second embodiment of the present invention is a method of operating a handheld apparatus. Please refer to FIG. 3. FIG. 3 is a flow chart demonstrating the operating method. Firstly, step S1 is performed according to the method to receive a set of RGB analog color temperatures of an environment which the handheld apparatus lies in from the RGB color temperature sensor. Secondly, step S2 is performed according to the method to convert the set of RGB analog color temperatures into a digital color temperature signal. Finally, step S3 is performed according to the method to generate an absolute color temperature related to the environment based on the digital color temperature signal.

In practical applications, the absolute color temperature is selected from a plurality of default results, such as a color-temperature conversion table, according to the digital color temperature signal in step S3.

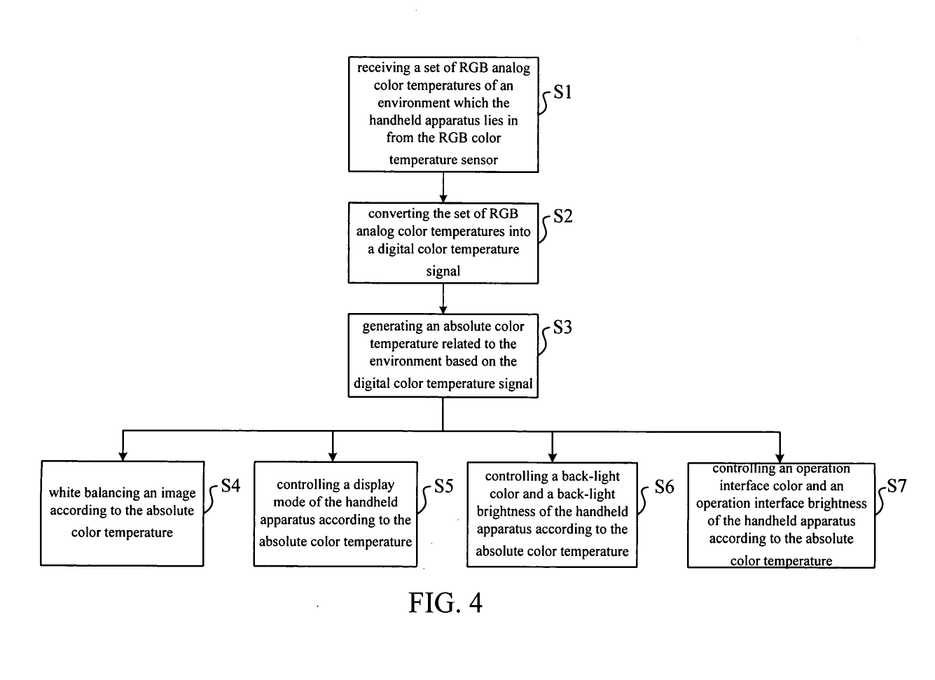

Furthermore, as illustrated in FIG. 4, the method further comprises steps S4˜S7. Steps S4˜S7 are performed based on the absolute color temperature obtained in step S3. The details of steps S4˜S7 are described as the followings.

Step S4 is to white balance an image according to the absolute color temperature. Step S5 is to control a display mode of the handheld apparatus according to the absolute color temperature. Step S6 is to control a back-light color and a back-light brightness of the handheld apparatus according to the absolute color temperature. Step S7 is to control an operation interface color and an operation interface brightness of the handheld apparatus according to the absolute color temperature.

Compared to the prior art, the handheld apparatus and the operating method thereof of the present invention can automatically white balance an image based on an absolute color temperature related to an environment which the handheld apparatus lies in. Thereby, the handheld apparatus and the operating method thereof of the present invention can avoid the bad result owing to the image is white balanced based on the relative color temperature. Moreover, the handheld apparatus could automatically adjust/change its display mode, the back-light color/brightness or the operation interface color/brightness according to the absolute color temperature related to the environment.

Although the present invention has been illustrated and described with reference to the preferred embodiment thereof, it should be understood that it is in no way limited to the details of such embodiment but is capable of numerous modifications within the scope of the appended claims.

What is claimed is:

1. A handheld apparatus electrically connected to a RGB color temperature sensor, the handheld apparatus comprising:
a receiving module, for receiving a set of RGB analog color temperatures of an environment which the handheld apparatus lies in from the RGB color temperature sensor;
a signal converting module electrically connected to the receiving module, for converting the set of RGB analog color temperatures into a digital color temperature signal; and
a color temperature calculating module electrically connected to the signal converting module, for generating an absolute color temperature related to the environment based on the digital color temperature signal.

2. The handheld apparatus of claim 1, wherein the set of RGB analog color temperatures is detected by the RGB color temperature sensor.

3. The handheld apparatus of claim 1, wherein the signal converting module is an ADC converter.

4. The handheld apparatus of claim 1 further comprising:
a capturing module, for capturing an image; and
an auto white balancing module electrically connected to the color temperature calculating module and the capturing module, for white balancing the image according to the absolute color temperature.

5. The handheld apparatus of claim 1 further comprising:
a database electrically connected to the color temperature calculating module, for storing a plurality of default results, wherein the color temperature calculating module selects the absolute color temperature from the plurality of default results according to the digital color temperature signal.

6. The handheld apparatus of claim 1 further comprising:
a controlling module electrically connected to the color temperature calculating module, for controlling a display mode of the handheld apparatus according to the absolute color temperature.

7. The handheld apparatus of claim 6 further comprising:
a back-light module electrically connected to the controlling module, and the controlling module controlling a back-light color and a back-light brightness of the back-light module according to the absolute color temperature.

8. The handheld apparatus of claim 6 further comprising:
an operation interface electrically connected to the controlling module, and the controlling module controlling an operation interface color and an operation interface brightness of the operation interface according to the absolute color temperature.

9. A method of operating a handheld apparatus electrically connected to a RGB color temperature sensor, the method comprising the following steps:
(a) receiving a set of RGB analog color temperatures of an environment which the handheld apparatus lies in from the RGB color temperature sensor;
(b) converting the set of RGB analog color temperatures into a digital color temperature signal; and
(c) generating an absolute color temperature related to the environment based on the digital color temperature signal.

10. The method of claim 9, wherein the set of RGB analog color temperatures is detected by the RGB color temperature sensor.

11. The method of claim 9 further comprising the following step:
white balancing an image according to the absolute color temperature.

12. The method of claim 9, wherein the absolute color temperature is selected from a plurality of default results according to the digital color temperature signal in step (c).

13. The method of claim 9 further comprising the following step:
controlling a display mode of the handheld apparatus according to the absolute color temperature.

14. The method of claim 9 further comprising the following step:
controlling a back-light color and a back-light brightness of the handheld apparatus according to the absolute color temperature.

15. The method of claim 9 further comprising the following step:
controlling an operation interface color and an operation interface brightness of the handheld apparatus according to the absolute color temperature.
